(19) United States
(12) Patent Application Publication
(10) Pub. No.: US 2002/0057056 A1
(43) Pub. Date: May 16, 2002

(54) Light-emitting diode

(76) Inventor: Tadahiro Okazaki, Kyoto-shi (JP)

Correspondence Address: ARENT FOX KINTNER PLOTKIN & KAHN, PLLC, Suite 600, 1050 Connecticut Avenue, N.W., Washington, DC, 20036-5339, US

(21) Appl. No.: 09/925,829

(22) Filed: Aug. 9, 2001

(30) Foreign Application Priority Data
Aug. 9, 2000 (JP) 2000-241505

(51) Int. Cl. H01J 63/04

(52) U.S. Cl. 313/512

(57) ABSTRACT

A light-emitting diode has a light-emitting chip, a base on which the light-emitting chip is mounted and that is provided with a reflector cup that reflects frontward the light radiated from the light-emitting chip, and a reflective member that reflects sideward both the light traveling frontward directly from the light-emitting chip and the light traveling frontward after being reflected from the reflector cup. The reflective member contains a fluorescent substance at least in a superficial portion thereof. The light reflected from the reflective member contains the light from the light-emitting chip and the light from the fluorescent substance. The light-emitting chip and the base are sealed in a translucent resin. The end surface of the translucent resin opposing the reflector cup is formed into a concave conical surface, and the resin containing the fluorescent substance is applied to this concave surface to form the reflective member.

### BACKGROUND OF THE INVENTION

1. Field of the Invention

The present invention relates to a light-emitting diode (hereinafter referred also as an LED), and particularly to an LED that exploits the light radiated from a fluorescent substance excited by the light radiated from a light-emitting chip.

2. Description of the Prior Art

LEDs of the type that exploits the excitation of a fluorescent substance to radiate light having a different wavelength from the light radiated from a light-emitting chip are proposed, for example, in Japanese Patent Applications Laid-Open Nos. H7-99345 and H5-152609.

FIG. 1 is a sectional view schematically showing an example of the structure of a conventional LED. A base 2 is provided with a reflector cup 3 that reflects light frontward, and a light-emitting chip 1 is mounted inside the reflector cup 3 by using a resin 5 containing a fluorescent material 4. All these are sealed in a translucent resin 6. In this structure, the fluorescent material 4 is excited by the light radiated from the light-emitting chip 1, and radiates light having a different wavelength from the light radiated from the light-emitting chip 1. Thus, it is possible to obtain light of varying wavelengths depending on the kind of the fluorescent material used.

In the conventional LED shown in FIG. 1, the fluorescent material 4 is, for example, mixed with the resin 5, or applied to the surface of the resin 5. This must be done within the extremely narrow region inside the reflector cup 3 where there are also provided leads 9, and thus causes the manufacturing process to involve delicate operation, which tends to lead to lower manufacturing efficiency.

On the other hand, in recent years, there has been an increasing demand for LEDs that efficiently radiate light of a desired color sideward, for example for use as indicators in CAD (computer-aided design) plotters. However, in LEDs that are commercially available on the market, efficiency is sought mainly in the frontward radiation, and thus they do not offer satisfactory efficiency in the sideward radiation.

### SUMMARY OF THE INVENTION

An object of the present invention is to provide an LED that efficiently radiates light of a desired color sideward but that can nevertheless be manufactured easily.

To achieve the above object, according to one aspect of the present invention, a light-emitting diode is provided with: a light-emitting chip; a base on which the light-emitting chip is mounted and that is provided with a reflector cup that reflects frontward the light radiated from the light-emitting chip; and a reflective member that reflects sideward both the light traveling frontward directly from the light-emitting chip and the light traveling frontward after being reflected from the reflector cup. Here, the reflective member contains a fluorescent substance at least in a superficial portion thereof.

This LED is provided with a reflective member that reflects sideward both the light traveling frontward directly from the light-emitting chip and the light traveling frontward after being reflected from the reflector cup. Since this reflective member contains a fluorescent substance, it produces, from the light radiated from a single light-emitting chip, light having a different wavelength therefrom, and radiates those two types of light simultaneously sideward. By appropriately selecting the combination of the light-emitting chip and the fluorescent substance, it is possible to obtain light of varying colors. Moreover, there is no need to form the fluorescent substance in the vicinity of the light-emitting chip. This eliminates too delicate operation, such as is required conventionally, from the manufacturing process, and thus helps increase manufacturing efficiency.

Preferably, a translucent resin is additionally provided in which the light-emitting chip and the base are sealed and of which the end surface opposing the reflector cup is formed into a conical concave surface, and the reflective member is provided on that end surface of the translucent resin. In this structure, since the reflective member has a conical surface, light can be radiated in all sideward directions. Moreover, the directions in which light is radiated can be easily adjusted by appropriately determining the shape and angle of the reflective surface. This widens the range of applications of the light-emitting diode.

Preferably, the light-emitting chip radiates blue light, and the fluorescent substance is a YAG (yttrium-aluminum-garnet)-based fluorescent substance. In this structure, it is possible to mix blue and yellow light and radiate white light sideward. This enhances the flexibility and usability of the light-emitting diode, because white light can be converted into light of any color by using a filter or the like that can convert the wavelength of light.

### BRIEF DESCRIPTION OF THE DRAWINGS

This and other objects and features of the present invention will become clear from the following description, taken in conjunction with the preferred embodiments with reference to the accompanying drawings in which:

FIG. 1 is a sectional view schematically showing an example of the structure of a conventional LED;

FIG. 2 is a sectional view schematically showing the structure of an LED embodying the invention;

FIG. 3 is a diagram schematically showing the principle of how an LED embodying the invention emits light;

FIG. 4 is a diagram showing an example of the manufacturing process of an LED embodying the invention;

FIG. 5 is a sectional view schematically showing another example of the portion containing the fluorescent substance;

FIG. 6 is a perspective view schematically showing another example of the shape of the reflective surface; and

FIG. 7 is a perspective view schematically showing another example of the shape of the reflective surface.

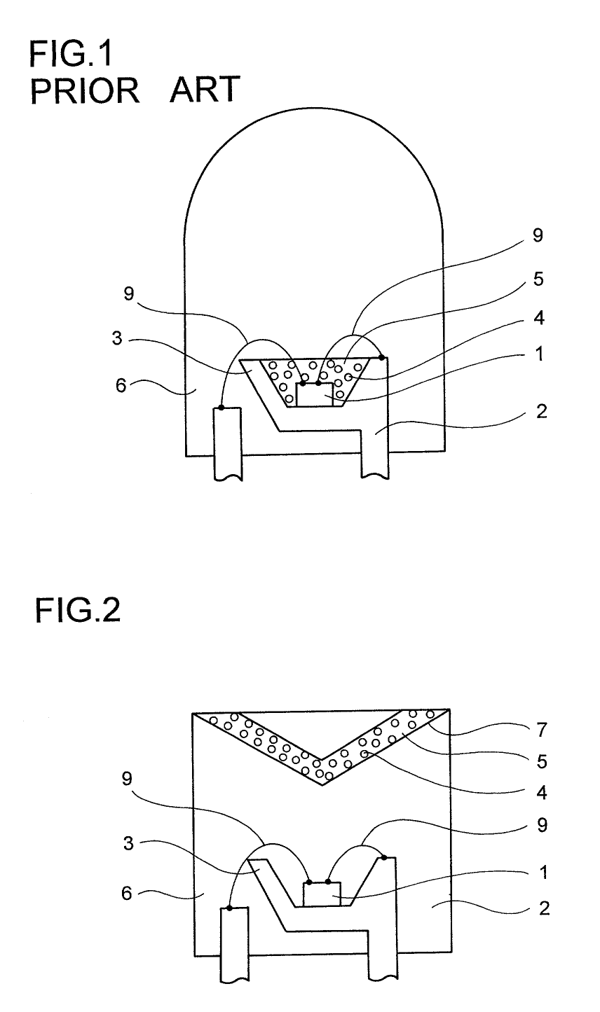

### DESCRIPTION OF THE PREFERRED EMBODIMENTS

Hereinafter, an embodiment of the present invention will be described. FIG. 2 is a sectional view schematically showing the structure of an LED embodying the invention. A base 2 is provided with a reflector cup 3 that reflects light frontward, and a light-emitting chip 1 is mounted inside the reflector cup 3. All these are sealed in a translucent resin 6, which has a concave conical surface 7 formed at its tip-side end, i.e. the end toward which the light traveling frontward inside the translucent resin 6 heads. This concave surface 7 serves as a reflective surface. To this reflective surface 7, a resin 5 containing a fluorescent substance 4 is applied.

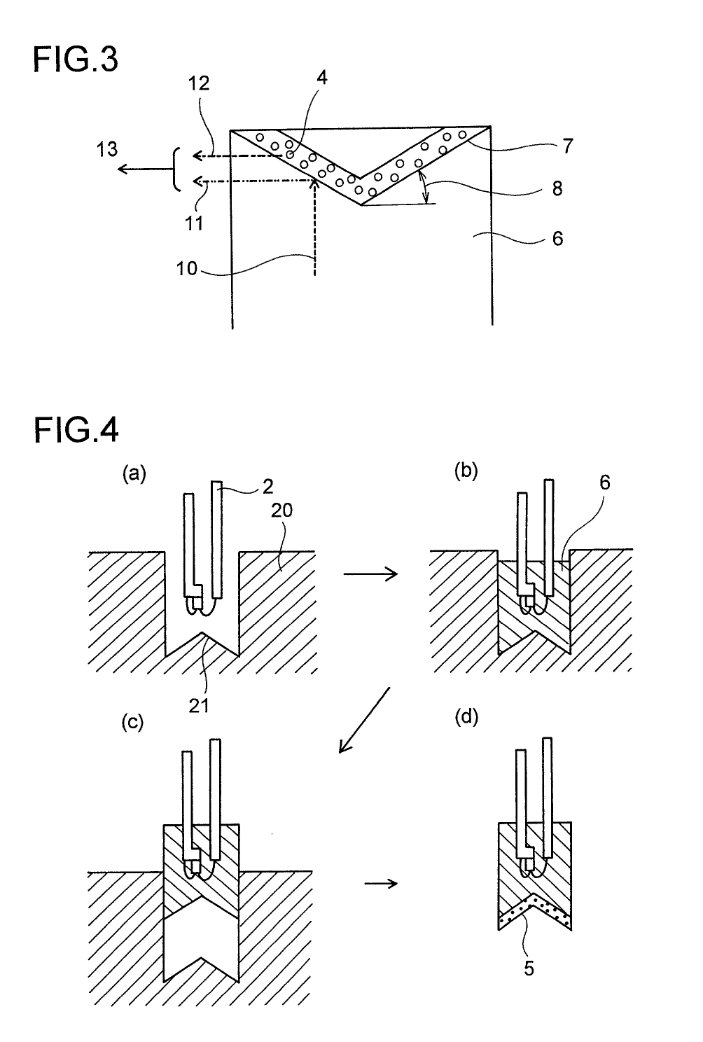

FIG. 3 schematically shows the principle of how an LED embodying the invention emits light. The light 10 that travels frontward, including both the light so traveling directly from the light-emitting chip and the light so traveling after being reflected from the reflector cup, is then reflected from the reflective surface 7 sideward as light 11. On the other hand, the fluorescent material 4 is excited by the light 10, and radiates light 12 having a different wavelength from the light 10, i.e. the light radiated from the light-emitting chip. As a result, the light 11 and the light 12 having two different wavelengths are mixed and radiated sideward as light 13.

It is possible to use a light-emitting chip of any kind and a fluorescent substance of any kind, as long as the fluorescent substance can convert the wavelength of the light radiated from the light-emitting chip to another wavelength; that is, an appropriate combination of those is selected that results in the radiation of light of a desired color. The adjustment and fine-tuning of the color of the radiated light are possible by controlling the kind, particle diameter, content, and other parameters of the fluorescent substance.

In a case where, as the light-emitting chip and the fluorescent substance, a light-emitting chip radiating blue light and a YAG (yttrium-aluminum-garnet)based fluorescent substance are used, the fluorescent substance is excited by the blue light and radiates yellow light. As a result, the blue light and the yellow light are mixed and radiated sideward as white light. White light can be converted into light of any color by using a filter or the like that can convert the wavelength of light.

There is no limitation on how the LED structured as described above is manufactured; for example, it can be manufactured by a conventionally known process. FIG. 4 shows an example of its manufacturing process. To form a concave conical surface that serves as a reflective surface at the tip-side end of the LED, a mold 20 is used that has a convex conical surface 21 formed therein as shown at (a) in FIG. 4. A base 3 having a light-emitting chip mounted thereon is put inside the mold 20, and the mold 20 is then filled with a thermosetting translucent resin 6 such as epoxy resin as shown at (b) in FIG. 4. After the translucent resin has hardened, it is released from the mold as shown at (c) in FIG. 4. Next, a resin 5 that has previously been mixed with powder of a fluorescent substance is applied to the surface of the concave conical surface as shown at (d) in FIG. 4. In this way, the LED is manufactured.

The purpose of using the fluorescent substance here is to convert the wavelength of the light radiated from the light-emitting chip to another wavelength. Therefore, the fluorescent substance has to be contained at least in a superficial portion of the reflective surface.

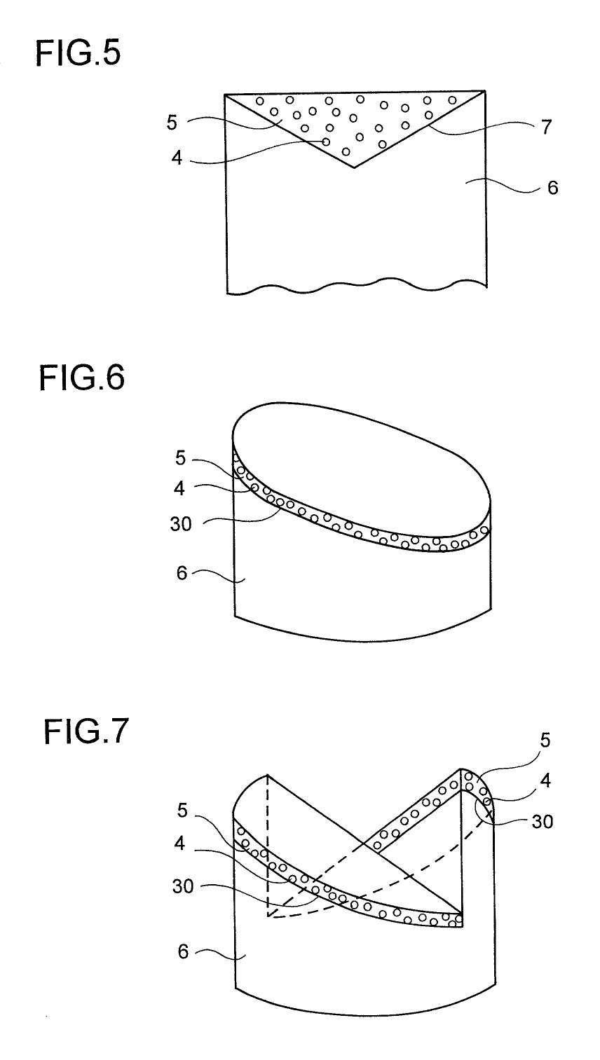

For example, as shown in FIG. 5, the concave conical portion may be completely filled with the resin 5 containing the fluorescent material 4. In practical terms, however, from the viewpoint of reducing material costs, it is advisable to form the portion containing the fluorescent substance as a layer to make efficient use of as little of the fluorescent substance as possible. Any means may be used to form the portion containing the fluorescent substance as a layer; for example, such a layer can be formed by applying the fluorescent substance to the target surface, or press-fitting the fluorescent substance thereon, or laying a film of the fluorescent substance thereon.

There is no particular limitation on the kind of the resin with which the fluorescent substance is mixed; for example, a translucent resin is used where the light radiated frontward is used, and a non-translucent resin is used where such light is not needed.

The shape of the reflective surface formed at the tip-side end of the LED is determined according to the requirements as to the light radiated sideward. For example, in a case where the tip-side end of the LED is formed into the shape of a cylinder cut along an inclined plane as shown in FIG. 6, only one reflective surface 30 is obtained, and thus light is radiated only in one sideward direction. In a case where the tip-side end of the LED is formed into the shape of a cylinder formed by combining together two half-cylinders each cut along an inclined plane as shown in FIG. 7, two reflective surfaces 20 are obtained, and thus light is radiated in two sideward directions.

Now, with reference to FIG. 3, how to adjust the directions in which light is radiated frontward and rearward will be described. The angle 8 of the reflective surface 7 determines the directions in which it reflects light, i.e. the directions in which light is radiated. Thus, by appropriately setting the angle, it is possible to radiate light in a desired manner. For example, to radiate light squarely sideward, the angle 8 is set at 45 degrees; to radiate light sideward with a frontward bias, the angle 8 is set within the range from 45 to 90 degrees; to radiate light sideward with a rearward bias, the angle 8 is set within the range from 0 to 45 degrees.

Obviously, many modifications and variations of the present invention are possible in light of the above teachings. It is therefore to be understood that within the scope of the appended claims, the invention may be practiced other than as specifically described.

What is claimed is:

1. A light-emitting diode comprising:
a light-emitting chip;
a base on which the light-emitting chip is mounted and that is provided with a reflector cup that reflects frontward light radiated from the light-emitting chip; and
a reflective member that reflects sideward both light traveling frontward directly from the light-emitting chip and light traveling frontward after being reflected from the reflector cup,
wherein the reflective member contains a fluorescent substance at least in a superficial portion thereof.

2. A light-emitting diode as claimed in claim 1, further comprising:
a translucent resin in which the light-emitting chip and the base are sealed and of which an end surface opposing the reflector cup is formed into a conical concave surface,
wherein the reflective member is provided on said end surface of the translucent resin.

3. A light-emitting diode as claimed in claim 1,
wherein the light-emitting chip radiates blue light, and
the fluorescent substance is a YAG (yttrium-aluminum-garnet)-based fluorescent substance.
